(19) United States
(12) Patent Application Publication
(10) Pub. No.: US 2013/0072096 A1
(43) Pub. Date: Mar. 21, 2013

(54) INTERNAL GEAR GRINDING MACHINE

(71) Applicant: Christian Hoerner, Altusried (DE)

(72) Inventor: Christian Hoerner, Altusried (DE)

(73) Assignee: LIEBHERR-VERZAHNTECHNIK GMBH, Kempten (DE)

(21) Appl. No.: 13/615,282

(22) Filed: Sep. 13, 2012

(30) Foreign Application Priority Data
Sep. 15, 2011 (DE) 10 2011 113 486.0

(51) Int. Cl. B23F 23/00; B23F 21/02

(52) U.S. Cl. 451/259; 451/177

(57) ABSTRACT

The present disclosure relates to an internal gear grinding machine having a grinding arm at which a grinding spindle is arranged and having a measuring head, wherein the measuring head advantageously includes a measuring sensor. Furthermore, in accordance with the present disclosure, the measuring head is movable from a grinding position into a measuring position via a linear guide.

### CROSS REFERENCE TO RELATED APPLICATION

This application claims priority to German Patent Application No. 10 2011 113 486.0, entitled “Internal Gear Grinding Machine,” filed Sep. 15, 2011, which is hereby incorporated by reference in its entirety for all purposes.

### TECHNICAL FIELD

The present disclosure relates to an internal gear grinding machine having a grinding arm at which a grinding spindle is arranged and having a measuring head, wherein the measuring head advantageously includes a measuring sensor.

### BACKGROUND AND SUMMARY

With external gear grinding machines, it is known in this respect to arrange the measuring head at the grinding head next to the grinding spindle at a linear guide via which the measuring head can be moved in the direction of the rotational axle of the grinding spindle toward the grinding wheel into a measuring position and away from the grinding wheel into a parking position. Such an arrangement of the measuring head is, however, not possible with internal gear grinding machines since the measuring head cannot remain in the region next to the grinding wheel for processing a workpiece.

The measuring head in internal gear grinding machines is therefore usually either only placed on the grinding head for carrying out a measurement and is removed again for processing a workpiece or it is arranged rotatably at the grinding head beneath the grinding wheel and is folded forward into a measuring position.

It is the object of the present disclosure to provide an internal gear grinding machine which, in contrast, allows a simplified handling of the measuring head.

This object is achieved in accordance with the present disclosure by an internal gear grinding machine having a grinding arm on which a grinding spindle is arranged. A measuring head is furthermore provided. The measuring head in this respect advantageously includes a measuring sensor. In accordance with the present disclosure, the measuring head is in this respect movable via a linear guide from a parking position into a measuring position. The present disclosure thus allows the measuring head to be moved into its measuring position, in which it is advantageously arranged in the region of the grinding wheel, for carrying out a measurement. If, in contrast, the workpiece should be processed, the measuring head can be moved back out of this interfering position again into the parking position.

The embodiment of the internal gear grinding machine in accordance with the present disclosure has the advantage in this respect that the measuring head does not have to be assembled or dismantled in a complex manner. The measuring head can furthermore be moved into its measuring position simply via only the linear guide. In accordance with the present disclosure, the grinding wheel therefore only has to be moved out of the denticulation in the direction of engagement and the measuring head moved into its measuring position for the measurement. The measuring head is then moved back into its parking position and the grinding wheel is moved into the denticulation in the direction of engagement for grinding.

The measuring head, in particular with a measuring sensor, can in this respect be used for centering or also for threading the grinding wheel into the denticulation. It can furthermore be used to measure the denticulation profile before or after the processing. For this purpose, the measuring head can be moved into its measuring position and then moved via the movement axles of the grinding machine toward the internal denticulation in order thus to determine the profile of the workpiece. The measuring head is in this respect in particular moved via the same movement axles of the grinding machine via which the grinding spindle can also be moved. In one example embodiment, the present disclosure includes method for operating the gear grinding machine to carry out the above described steps, as well as the other steps and operations described herein. The grinding machine may include a control system having computer readable storage media with code thereon, the code including instructions for operating the gear grinding machine according to such methods.

The measuring head is in this respect advantageously movable orthogonal to the rotational axle of the grinding spindle in accordance with the present disclosure. Unlike the movability in the direction of the rotational axle of the grinding spindle known in external gear grinding machines, this arrangement of the linear guide in the internal gear grinding machine allows the measuring head to be moved away from the interfering region.

In the internal gear grinding machine in accordance with the present disclosure, the grinding spindle is arranged at a grinding arm via which it can be moved into the workpiece in the dipping direction to process the internal denticulation of the workpiece from inside. The grinding arm therefore extends in the dipping direction and defines the maximum width of the toothed wheel, which can be ground by the internal gear grinding machine, by its length.

Provision is in this respect made in a further advantageous manner that the measuring head is movable in the dipping direction. There is usually also a relatively large amount of construction space in this direction with an internal gear grinding machine so that a corresponding linear guide can be provided despite the tight space relationships.

Further advantageously, the linear guide is arranged at the grinding arm in accordance with the present disclosure. In particular when the measuring head is movable in the dipping direction, the grinding arm extending in this direction can thus be used as construction space for the linear guide.

The linear guide can in this respect in particular be arranged on the side of the grinding arm facing the internal denticulation region. The measuring head can hereby be moved without problem toward the internal denticulation of the workpiece which is to be measured.

The linear guide is in this respect advantageously arranged above the grinding spindle in the dipping direction. Unlike with measuring sensors arranged beneath the grinding spindle, no additional construction space is thus required by the measuring sensor. The linear guide can thus in particular extend in the dipping direction at the grinding arm, where a certain construction space is anyway available due to the required length of the grinding arm.

The linear guide is in this respect advantageously arranged at an element of the grinding arm which is located above a grinding wheel arranged at the grinding spindle. The linear guide can in this respect in particular be arranged in the grinding plane of the grinding spindle.

In a further advantageous manner, the linear guide is in this respect set back in the engagement direction with respect to the front interfering edge of the grinding spindle suspension or is arranged at the same level. The linear guide itself thus does not increase the size of the interfering edges at the grinding arm.

In a further advantageous manner, the measuring head is arranged at a carrier arm which is guided at the linear guide. The linear guide thus does not have to reach up to the measuring position of the measuring head, but the end of the linear guide can rather be arranged remote from the measuring position of the measuring head. The measuring head can in this respect advantageously be movable by the shape of the carrier arm in front of a grinding wheel arranged at the grinding spindle.

The carrier arm advantageously projects over the end of the linear guide in the direction of displacement and protrudes from the linear guide, with the measuring head advantageously being arranged at its end. The carrier arm in particular makes it possible by its shape to move the measuring head in the grinding plane in front of a grinding wheel.

The carrier arm in particular extends in this respect toward the front and downwardly into a position before the grinding wheel.

Provision can furthermore be made that the measuring head is arranged at a measuring head carriage which is movable at the linear guide. In this respect, a carrier arm can in particular be provided at the measuring head carriage as was already described above.

The measuring head carriage is in this respect advantageously arranged at least partly in a housing in the parking position and can be moved from this into the measuring position via the linear guide. The measuring head carriage can hereby be moved out of the measuring position and out of the interfering region into the housing which simultaneously serves the protection of the measuring head carriage and of the measuring head. The housing can furthermore have a carrying function for the grinding arm and/or be anyway present and now also be used for the measuring head carriage.

The measuring head carriage is in this respect advantageously completely movable into the housing, advantageously so that the carrier arm and/or the measuring head itself is/are also arranged in the housing in the parking position.

The housing is in this respect advantageously arranged above the grinding wheel.

Provision can furthermore be made that the housing is arranged in a part of the grinding arm which serves the connection to the gear grinding machine.

Provision can in particular be made in this respect that the grinding arm is connected in the horizontal direction via a housing section to a grinding arm stand which extends outwardly beyond the workpiece on the processing of the workpiece. Provision can be made in this respect in accordance with the present disclosure that the measuring head carriage can be moved into this housing section. This housing section in this respect advantageously has a carrying function for the grinding arm.

Provision can furthermore be made in accordance with the present disclosure that the measuring head can be moved along the linear guide via a drive. Provision can in this respect in particular be made that the drive is controlled via the machine control so that the measuring head carriage can be moved automatically.

Provision can furthermore be made that the drive takes place pneumatically.

Alternatively, it is, however, likewise conceivable that the measuring head has to be moved manually.

The measuring position of the measuring head in the internal gear grinding machine in accordance with the present disclosure can furthermore be defined via an end abutment toward which the measuring head carriage can be moved. It is hereby achieved that the position of the measuring head in the measuring position is exactly defined, which ensures correct measuring results.

In this respect, an abutment monitoring sensor is advantageously provided which checks that the measuring head carriage is actually in the end position. In this respect, a pneumatic abutment monitoring sensor can advantageously be used.

The present disclosure is particularly used in internal gear grinding machines, wherein the grinding spindle is arranged at the grinding arm without the interposition of a rotational axle. Alternatively or additionally, the grinding spindle can be arranged at the grinding arm without the interposition of a shift axle. Further alternatively or additionally, the grinding spindle can be arranged at the grinding arm without the interposition of an axle extending in the dipping direction.

Provision can in this respect in particular be made that all the movements of the grinding spindle, except for its rotational movement, take place by a movement of the grinding arm, whereas the grinding spindle itself is arranged rigidly at the grinding arm.

Provision can in this respect furthermore be made that the grinding arm is movable via axles which are arranged outside the radius of a workpiece to be processed.

Provision can furthermore be made that the grinding arm is rotatable via a rotational axle. Provision can furthermore be made that the grinding arm is movable in the dipping direction via a first linear axle. Provision can furthermore be made that the grinding arm is movable in the direction of the rotational axle of the grinding spindle via a shift axle. Provision can furthermore be made that the grinding arm is movable in the direction of engagement via a linear axle.

In accordance with a further aspect, the present disclosure includes a gear grinding machine having a grinding spindle and having a measuring head movable via a linear guide. The measuring head in this respect advantageously again includes a measuring sensor. In accordance with this aspect of the present disclosure, the gear grinding machine is characterized in that the measuring head is movable orthogonal to the rotational axle of the grinding spindle. This arrangement of a linear guide orthogonal to the rotational axle of the grinding spindle in this respect not only has advantages in the arrangement of the measuring head with internal gear grinding machines, but also with external gear grinding machines. The measuring head is in this respect movable in the dipping direction.

The gear grinding machine in this respect advantageously has the features which were described above with respect to the internal gear grinding machine in accordance with the present disclosure without this having to relate to the embodiment of an internal gear grinding machine. The linear guide can in this respect in particular be arranged above the grinding spindle in the dipping direction. Provision can furthermore be made that the linear guide is set back with respect to the front most interfering edge of the grinding spindle suspension in the engagement direction or lies at the same plane. Provision can furthermore be made that the linear guide is arranged approximately in the grinding plane.

The measuring head can furthermore be arranged at a carrier arm which is guided at a linear guide. The measuring head is in this respect advantageously movable by the shape of the carrier arm in front of a grinding wheel arranged at the grinding spindle.

The measuring head can furthermore be arranged at a measuring head carriage, in particular at a measuring head carriage having a carrier arm such as was described above.

The measuring head carriage can furthermore be arranged at least partly and advantageously completely in a housing in the parking position and can be movable out of this into the measuring position via the linear guide. The housing can in this respect in particular be arranged above the grinding wheel.

The measuring head can furthermore be movable via a drive at the linear guide, with the drive advantageously taking place pneumatically and/or with the drive advantageously being controlled via the machine control.

Provision can furthermore be made that the measuring position of the measuring head is defined via an end abutment toward which the measuring head carriage can be moved. In this respect, an abutment monitoring sensor is advantageously provided, advantageously a pneumatic abutment monitoring sensor.

In an advantageous manner, the linear guide is in this respect arranged at the grinding head of the gear grinding machine without a movement axle being arranged between the element at which the linear guide is arranged and the grinding spindle.

In the gear grinding machine described in accordance with the further aspect of the present disclosure, it can in particular be an internal gear grinding machine as was presented above. Alternatively, however, it can also be an external gear grinding machine.

The internal gear grinding machines in accordance with the present disclosure can in this respect either be equipped with a special internal grinding head or they can have a grinding arm designed as an attachment grinding head which is attached to a machine stand which can be used for external denticulations.

The internal gear grinding machines in accordance with the present disclosure advantageously include a workpiece support at which the workpiece can be clamped and rotated by a drive so that the grinding head of the grinding machine can come into engagement with different regions of the workpiece.

The movement axles of the internal gear grinding machines and gear grinding machines in accordance with the present disclosure are advantageously controlled via NC axes and a grinding machine control. The measuring head is in this respect advantageously in connection with the grinding machine control.

In addition to the internal gear grinding machine and the gear grinding machine themselves, the present disclosure furthermore includes a measuring sensor carriage and a linear guide for such a gear grinding machine and such an internal gear grinding machine.

In this respect, the measuring head is in particular arranged at a carrier arm which is guided at the linear guide via the measuring head carriage. The carrier arm advantageously projects over the end of the linear guide in the direction of displacement and protrudes from the linear guide, with the measuring head advantageously being arranged at its end. The carrier arm in particular makes it possible by its shape to move the measuring head in the grinding plane in front of a grinding wheel.

The present disclosure will now be described in more detail with reference to embodiments and to drawings.

### BRIEF DESCRIPTION OF THE FIGURES

FIG. 1 shows an embodiment of a grinding arm of an internal gear grinding machine in accordance with the present disclosure with the measuring sensor in a measuring position.

FIG. 2 shows the embodiment of a grinding arm of an internal gear grinding machine in accordance with the present disclosure with the measuring head in the parking position.

FIG. 3 shows an embodiment of an internal gear grinding machine in accordance with the present disclosure with the grinding arm in accordance with the present disclosure with the measuring head in a measuring position.

FIG. 4 shows the embodiment shown in FIG. 3 with the measuring head in the parking position. FIGS. 1-4 are drawn approximately to scale, although other relative dimensions may be used, if desired.

### DETAILED DESCRIPTION

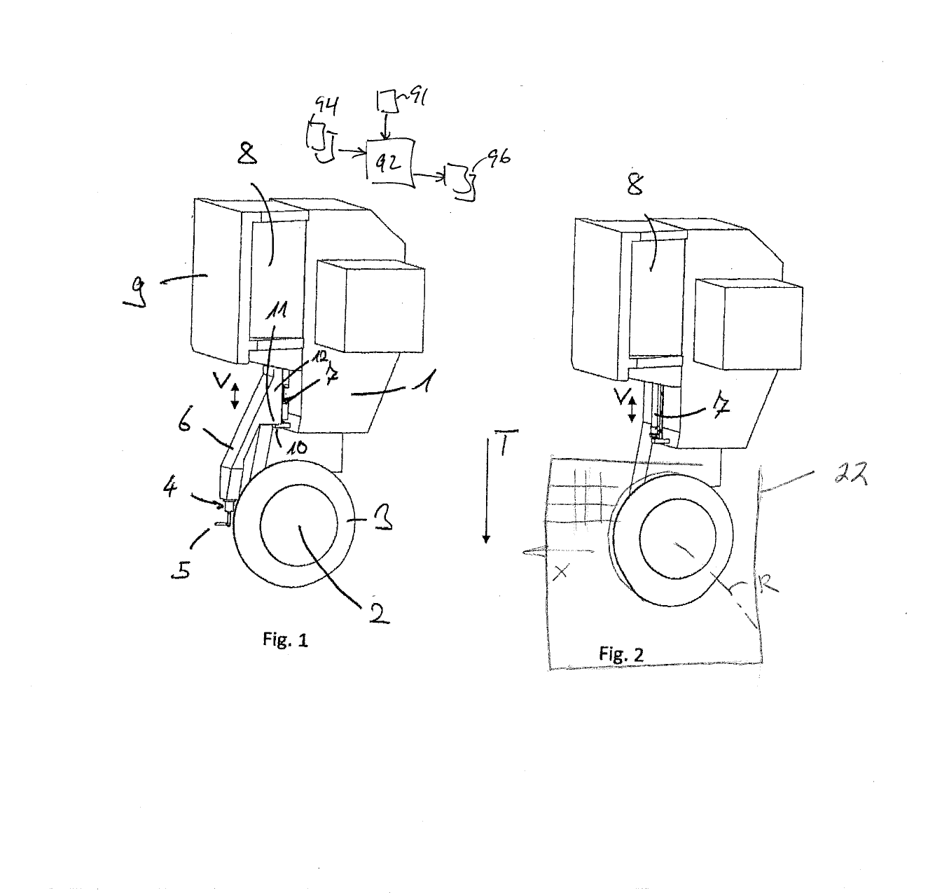

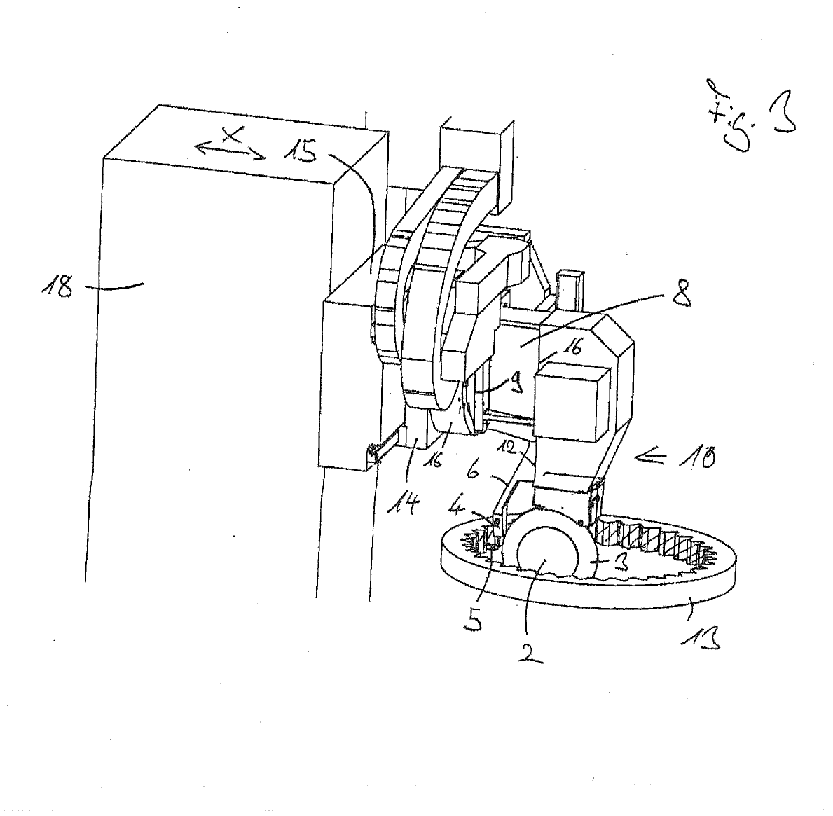

An embodiment of the present disclosure will now be described in more detail with reference to FIGS. 1 and 2. The internal gear grinding machine in accordance with the present disclosure in this respect has a grinding arm 1 at whose lower end a grinding spindle 2 with the grinding wheel 3 arranged thereon is arranged. In the embodiment, in this respect, no further attachments are provided beneath the grinding spindle so that no construction space is wasted toward the bottom.

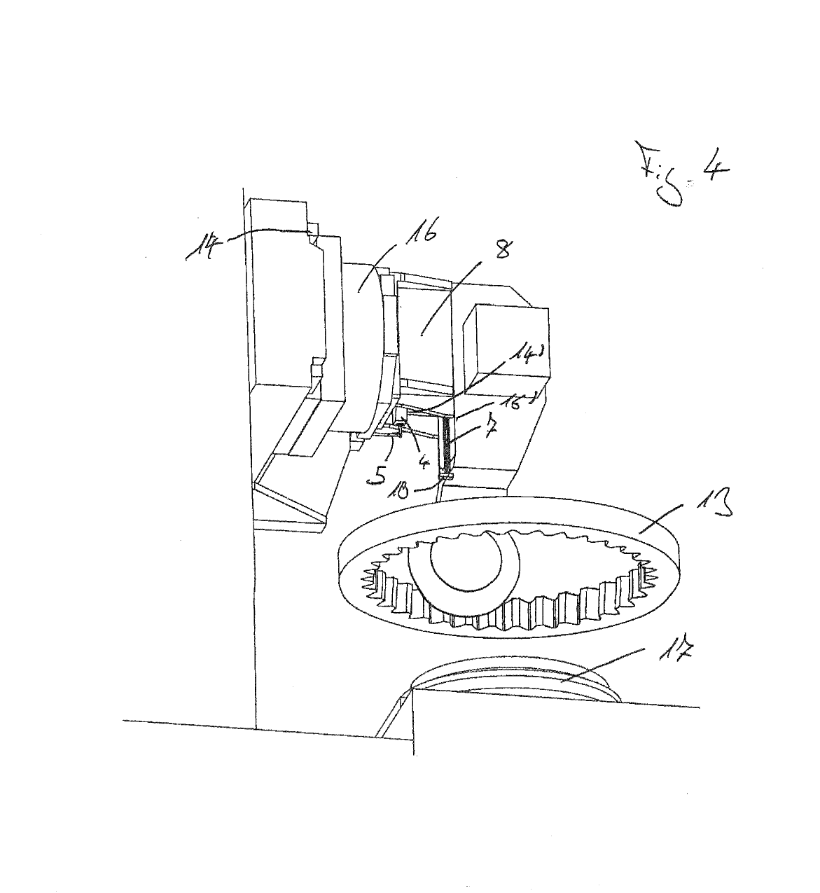

The measuring head 4 in this respect has a measuring sensor which is triggered by the movement of a measuring sensing element 5. The measuring sensing element 5 in this respect extends toward the front in the engagement direction (X) away from the measurement head. The engagement direction is perpendicular to the rotational axis of the workpiece in which the grinding tool is moved to engage with the workpiece. Such movement may be performed by a linear drive of the machine stand part 18 (see FIG. 3)

In this respect, the centering or also the threading of the grinding wheel into the denticulation of a workpiece and/or the measuring of the denticulation can be carried out via the measuring head in accordance with the present disclosure after or before the processing.

In accordance with the present disclosure, the measuring head 4 is now arranged on a carriage 12 which is movable along a linear guide 7. The linear guide 7 is in this respect arranged orthogonal to the rotational axle of the grinding wheel and parallel to the dipping direction T into the workpiece.

The measuring head carriage can thus be moved out of the interfering region against the dipping direction of the grinding head into a parking position or into the interfering region into its measuring position.

In accordance with the present disclosure, the linear guide 7 is in this respect arranged at the grinding arm 1, and indeed in the embodiment above the grinding wheel 3 at a region of the grinding arm which is arranged above the grinding spindle 2. The linear guide 7 can in this respect in particular be arranged in the grinding plane of the grinding wheel 3. The grinding plane 22 is a plane perpendicular to the rotating axis R of the grinding tool forming the middle plane of the grinding too (see FIG. 2)

In this respect, the measuring head 4 is seated at the tip of a carrier arm 6 which connects the measuring head 4 to the carriage 12. In this respect, the carrier arm 6 projects to the front and downwardly so that it does not come into contact with the grinding wheel 3 and the measuring head 4 is nevertheless arranged in the measuring position before the grinding wheel.

The carriage 12 with the carrier arm 6 can then be moved upwardly out of the interfering region for grinding. The carriage and the carrier arm 6 are in this respect moved into a housing section 8 of the grinding arm which serves as the connection with the machine stand, which includes all of the elements 14, 15, 16, and 18 shown at the left hand side of FIG. 3, up to the connection surface 9, the machine stand carrying the drives for moving the grinding head of the machine. The space anyway present there can hereby be ideally used.

In accordance with the present disclosure, an opening only has to be provided at the lower side of the housing section 8 through which opening the carriage and the carrier arm can be moved upwardly into the housing region. The linear guide can furthermore extend up to and into the housing region.

The measuring head carriage 12 is particularly driven so that the measuring head can be moved via the machine control 92 of the gear grinding machine from the parking position into the measuring position and vice versa. The machine control 92 may include a controller receiving input from various sensors 94, including sensor 10, and adjusting various actuators 96, including the actuator powering movement of the linear slide, the control of the grinding wheel and arm, etc.

An exactly reproducible end position of the measuring head carriage in the measuring position is in this respect ensured by an end abutment 10 toward which the measuring head carriage 11 can be moved. A pneumatic abutment monitoring sensor 91 is furthermore provided there which checks the end position.

The drive of the measuring sensor carriage can also take place pneumatically in accordance with the present disclosure.

The embodiment of the gear grinding machine in accordance with the present disclosure is in this respect a gear grinding machine with a grinding arm without a movement axle for moving the grinding spindle 2 which is accordingly rigidly arranged at the grinding arm 1.

All the movements which are required for grinding an internal denticulation, except for the rotational movement for the grinding wheel 3, are accordingly carried out by the movement of the total grinding arm 1. For this purpose, the grinding arm with the connection element 9 is arranged via movement axles, not shown, at a grinding stand likewise not shown. The movement axles and the grinding stand are in this respect located outside the radius of the workpiece to be processed.

Alternatively, the present disclosure can, however, also be used with gear grinding machines which have a special internal grinding head which has its own movement axles.

In this respect, a part of the grinding arm can in particular form a grinding head which is movable or rotatable with respect to a second part of the grinding arm by one or more movement axles. In this case, the linear axle 7 is advantageously arranged at that part of the grinding arm at which the grinding spindle 2 is arranged without the interposition of movement axles so that the linear axle 7 is moved along with the grinding spindle 2.

Alternatively, the linear axle 7 could, however, also be arranged at a part of the grinding arm with respect to which the grinding spindle 2 can be moved via movement axles.

In FIGS. 3 and 4, an embodiment of an internal gear cutting machine in accordance with the present disclosure is now shown in which the grinding arm shown in FIGS. 1 and 2 is used.

In this respect, the movement axles are also shown via which the grinding arm 10 can be moved. In this respect, the grinding arm is first connected via the connection surface 9 to a rotational axle 16 via which the total grinding arm can be pivoted to manufacture helical gearing arrangements. A carriage 14 is furthermore provided which allows a lateral displacement of the grinding arm in the shift direction. The carriage 15 further allows a displacement of the grinding arm in the dipping direction. Furthermore, the grinding arm can be moved in the engagement direction by a displacement of the machine stand 18 to move the grinding wheel into engagement with the workpiece 13 or out of the denticulation. The workpiece is rotatable about a vertical axis of rotation via the workpiece spindle 17. In this respect, it can also be recognized in FIG. 3 how the workpiece 13 is measured via the measuring head 4. The workpiece includes an inner denticulation region designated by the hatching shown in FIG. 3, referring to the area of having teeth.

The housing section 8 is shown in a view obliquely from below in FIG. 4 so that it can be recognized that it was furnished with an opening 14′ through which the carrier arm 6 and the measuring head carriage 10 can be moved upwardly into the housing section. It can furthermore be recognized how the linear guide 7 is arranged at the vertically extending grinding arm element 16′ which is connected to the housing section 8.

It can also be recognized particularly easily in FIGS. 3 and 4 that the present disclosure allows a particularly efficient change between grinding operation and measuring operation since for this purpose only the grinding wheel 3 has to be moved a little out of the denticulation. The measuring sensing element 5 can then be moved into the desired position only by a movement of the measuring head into its measuring position.

The measurement now takes place by a movement of the grinding arm via the movement axles of the machine until the measuring sensing element 5 respectively comes into contact with the surface of the denticulation and hereby triggers the measuring sensor.

The measuring head also only has be moved out of the interfering region for restarting the grinding operation without the grinding head having to be moved with the grinding wheel 3 for this purpose.

In addition, the measuring head and the carrier arm are protected by the arrangement in accordance with the present disclosure in grinding operation by the housing section 8 which surrounds it. A cut-out for the sensing element 5 can in this respect be provided outwardly at the housing section and the sensing element can be moved into it.

Alternatively to the embodiment shown here with an internal gear grinding machine, the measuring head 4 movable via the linear axle 7 could also be arranged in the same manner at an external gear grinding machine. In this respect, it is advantageously arranged in the same manner at the grinding head above the grinding spindle 2 and movable in the dipping direction. The embodiment of linear guide 7, measuring head carriage 12, carrier arm 6 and measuring head 4 can in this respect be the same as with the internal gear grinding machine in accordance with the present disclosure.

The measuring head can also be moved upwardly out of its measuring position away from the interfering region without problem.

1. An internal gear grinding machine comprising:
a grinding arm at which a grinding spindle is arranged and having a measuring head, wherein the measuring head is movable from a parking position into a measuring position via a linear guide.

2. The internal gear grinding machine in accordance with claim 1, wherein the measuring head is movable orthogonal to a rotational axle of the grinding spindle, with the measuring head being movable in a dipping direction, and wherein the measuring head includes a measuring sensor.

3. The internal gear grinding machine in accordance with claim 1, wherein the linear guide is arranged at the grinding arm.

4. The internal gear grinding machine in accordance with claim 1, wherein the linear guide is arranged on a side of the grinding arm facing an inner denticulation region.

5. The internal gear grinding machine in accordance with claim 1, wherein the linear guide is arranged above the grinding spindle in a dipping direction; wherein the linear guide is arranged at an element of the grinding arm which is located above a grinding wheel arranged at the grinding spindle; and/or wherein the linear guide is set back in an engagement direction with respect to a front most interfering edge of a grinding spindle suspension or is at the same level of the front most interfering edge.

6. The internal gear grinding machine in accordance with claim 1, wherein the measuring head is arranged at a carrier arm which is guided at the linear guide, with the measuring head being movable by a shape of the carrier arm in front of a grinding wheel arranged at the grinding spindle.

7. The internal gear grinding machine in accordance with claim 1, wherein the measuring head is arranged at a measuring head carriage, including a measuring head carriage in the form of a carrier arm, wherein the measuring head carriage is arranged at least partly in a housing in the parking position and is moveable out of said housing into the measuring position via the linear guide, with the housing being arranged above the grinding wheel and/or with the housing being arranged in a part of the grinding arm which serves as a connection to the gear grinding machine.

8. The internal gear grinding machine in accordance with claim 1, wherein the measuring head is movable via a drive at the linear guide; wherein the drive takes place pneumatically; and/or wherein the drive is controlled via a machine control system.

9. The internal gear grinding machine in accordance with claim 1, wherein the measuring position of the measuring head is defined via an end abutment toward which the measuring head carriage is movable, with an abutment monitoring sensor being provided thereon.

10. The internal gear grinding machine in accordance with claim 1, wherein the grinding spindle is arranged at the grinding arm without an interposition of a rotating axle.

11. The internal gear grinding machine in accordance with claim 1, wherein the grinding spindle is arranged at the grinding arm without the interposition of a shift axle.

12. The internal gear grinding machine in accordance with claim 1, wherein the grinding spindle is arranged at the grinding arm without the interposition of an axle extending in a dipping direction.

13. The internal gear grinding machine in accordance with claim 1, wherein the grinding arm is movable via axles which are arranged outside a radius of a workpiece to be processed.

14. The internal gear grinding machine in accordance with claim 1, wherein the grinding arm is rotatable via a rotating axle and is movable in a dipping direction via a first linear axle and/or is movable in a direction of a rotating axle of the grinding spindle via a shift axle and/or is movable in an engagement direction via a linear axle.

15. A gear grinding machine comprising a grinding spindle and having a measuring head movable via a linear guide, wherein the measuring head is movable orthogonal to a rotating axis of the grinding spindle.

16. The gear grinding machine in accordance with claim 15, wherein the linear guide is arranged above the grinding spindle in the dipping direction, wherein the measuring head includes a measuring sensor, and wherein the measuring head is movable in a dipping direction.

17. The gear grinding machine in accordance with claim 15, wherein the linear guide is arranged at an element of the grinding arm which is located above a grinding wheel arranged at the grinding spindle.

18. The gear grinding machine in accordance with claim 15, wherein the linear guide is set back in an engagement direction with respect to a front most interfering edge of a grinding spindle suspension or is at the same level of the front most interfering edge.

19. The gear grinding machine in accordance with claim 15, wherein the measuring head is arranged at a carrier arm which is guided at the linear guide, with the measuring head being movable by a shape of the carrier arm in front of a grinding wheel arranged at the grinding spindle.

20. The gear grinding machine in accordance with claim 1, wherein the measuring head is arranged at a measuring head carriage, including a measuring head carriage in the form of a carrier arm, wherein the measuring head carriage is arranged at least partly in a housing in the parking position and is moveable out of said housing into the measuring position via the linear guide.
